(19) United States
(12) Patent Application Publication
(10) Pub. No.: US 2012/0203656 A1
(43) Pub. Date: Aug. 9, 2012

(54) Method And System For Customizing Bulk Purchases Of Consumer Products

(76) Inventors: James Michael Schuh, Appleton, WI (US); Mary Watt Goggans, Appleton, WI (US); James Christian Buchta, Plano, TX (US); Jerome Joseph Kristynik, Houston, TX (US); Matthew Wolf, McKinney, TX (US)

(21) Appl. No.: 13/020,865

(22) Filed: Feb. 4, 2011

(51) Int. Cl. G06Q 30/00

(52) U.S. Cl. 705/26.5; 705/27.1

(57) ABSTRACT

A method of customizing bulk purchases of consumer personal care products includes providing a consumer-accessible electronic display configured to allow a consumer to purchase the personal care products by selecting between first and second order counts of personal care products, wherein the first and second order counts are multiples of a package count of a first pre-set package of the personal care products, of a second pre-set package of the personal care products, or of a combination thereof, and fulfilling the purchase by determining the number of first and second pre-set packages to ship to meet the selected order count.

### BACKGROUND

In the relatively recent past, warehouse-type stores have evolved and become popular. In such types of stores, consumers can buy bulk purchases of products at a reduced price. For instance, in warehouse-type outlets and in various other types of outlets, consumers can purchase large quantities of personal care products, such as diapers, in relatively large bundles. Such bulk purchases can require a high cash outlay, but do provide financial incentives over the long term in comparison to purchasing small packages from conventional grocery stores.

Buying in bulk, however, can have its disadvantages especially for consumers purchasing personal care products, such as diapers and other absorbent articles. For example, purchasing in bulk requires a trip to a warehouse-type outlet and purchasing a large number of products in a large corrugate box. In another example, the infant or child for which the purchase is made can transition to a larger size prior to consuming all of the products obtained in the bulk purchase. For parents who have more than one child, the bulk purchase becomes even more problematic, in that the parents must purchase two different large quantities and assume the risk that one of the children will outgrow the size contained in the bulk purchase. Finally, there is no additional discount for purchasing multiple bulk bundles. In view of the above, some consumers prefer to avoid bulk purchases even at lower prices.

In addition, online retailers want to avoid selling bulk quantities of products because it can entail shipping a large corrugate box within another box, adding to the cost and waste. Also, some retailers can be restricted from offering standard bulk packaging because of exclusive arrangements between the manufacturer and other retailers, particularly in other sales channels.

Consequently, a need currently exists for a method and system for customizing bulk purchases of consumer personal care products so that consumers can purchase multiple related products.

### SUMMARY

In general, the present disclosure is directed to a method and system for offering shoppers the customization of bulk purchases of related personal care products.

For example, in one aspect, the present disclosure is directed to a method of customizing bulk purchases of consumer personal care products including providing a consumer-accessible electronic display configured to allow a consumer to purchase the personal care products by selecting between first and second order counts of personal care products, wherein the first and second order counts are multiples of a package count of a first pre-set package of the personal care products, of a second pre-set package of the personal care products, or of a combination thereof, and fulfilling the purchase by determining the number of first and second pre-set packages to ship to meet the selected order count.

The method further includes a method of customizing bulk purchases of consumer personal care products including providing a consumer-accessible electronic display configured to allow a consumer to assemble and purchase a virtual combination of personal care products having one of first and second order counts, wherein the first and second order counts are multiples of a package count of a first pre-set package of the personal care products, of a second pre-set package of the personal care products, or of a combination thereof, wherein the second order count is greater than the first order count, wherein the first order count has a price per product, and wherein the second order count has a price per product less than the price per product of the first order count, and fulfilling the purchase by determining the number of first and second pre-set packages to ship to meet the assembled combination.

As described above, the method is generally directed to at least two related personal care product forms and to variants thereof. As used herein, related personal care product forms are personal care products that are designed to accomplish the same tasks (i.e. diapers and other articles), or used in conjunction with each other (i.e. baby wipes in conjunction with diapers) or products sold to the same age group or products sold to the same gender (i.e. feminine care products). A variant of a product form, on the other hand, includes a variation in the same product. For instance, a variant can include a different size, a different scent, an addition of an additive that does not significantly change the character of the underlining product, or the like.

For example, in one aspect, the related personal care product forms can include absorbent articles for infants and children.

The present disclosure is also directed to a system for selling customized bulk purchases of personal care products to consumers. The system includes a consumer-accessible electronic display configured to allow a consumer to purchase the personal care products by selecting between first and second order counts of personal care products, wherein the first and second order counts are multiples of a package count of a first pre-set package of the personal care products, of a second pre-set package of the personal care products, or of a combination thereof; and an order fulfillment mechanism configured to determine the number of first and second pre-set packages to ship to meet the selected order count.

Other features and aspects of the present disclosure are discussed in greater detail below.

### DETAILED DESCRIPTION

It is to be understood by one of ordinary skill in the art that the present discussion is a description of exemplary aspects of the present disclosure only, and is not intended as limiting the broader aspects of the present disclosure.

In general, the present disclosure is directed to a method and system for customizing bulk purchases of related personal care products by consumers. Currently, at some retail outlets, consumers have the option of buying a single bulk package of personal care products that are all the same. By buying in large quantities, consumers can take advantage of a lower price per unit. In some instances, however, not only does the bulk purchase represent a large price outlay but can provide the consumer with more of the product than they need. In this regard, the present disclosure is directed to a system and method of marketing personal care products in which the consumer is allowed to purchase a pre-determined number of personal care products at a set price. By purchasing a plurality of personal care products together, the bulk price is at a lower price per unit of product versus buying smaller packages separately.

For example, in one aspect, the present disclosure is directed to a system that includes the novel integration of electronic commerce and personal care products. More particularly, according to the present disclosure, personal care products and their variants can be offered together in an electronic medium. For instance, in one aspect, a single website can be used that offers each of the product forms and their variants. The products can include, for instance, any related personal care products. The products can include, for instance, absorbent articles such as diapers, training pants, swim pants, and the like. Other products can include feminine, adult, incontinence, and enuretic products. The products included in a particular website or other electronic display can include related personal care products. Related products, for instance, can be products used by a certain group of individuals, such as children and infants, can include products used by a particular gender, such as feminine care products, or can include products used in conjunction with one another, such as diapers and baby wipes.

The display can include variants of the products, as well as different sizes of the products. Variants can include, for instance, enhanced versions of the products including greater absorbency, wetness sensing, and the like. Variants can also include the difference between products that are scented or unscented or products that contain additional additives or ingredients that do not significantly change the overall product. The products and variants can also be varied or rotated to provide an ongoing variety of seasonal or other limited-edition offerings.

The products and their variants can be packaged separately or together in quantities that are smaller than typical bulk packages. In one aspect, products are packaged in pre-set packages—standard retail packaging with package counts that accommodate desired retail price points. The bulk price, on the other hand, can be based on the consumer purchasing a larger quantity of the products.

Each pre-set package is assigned a stock-keeping unit (SKU) unique to a particular combination of count, size, variant, and gender. For example, four sizes of three variants in both genders yields 24 SKUs per level of package count. In other words, adding an additional package count for each combination, such as adding a bulk package of each combination, adds 24 more SKUs to track, ship, distribute, and for which to find shelf space. Adding virtual packages such as those described herein can add bulk packaging without adding any SKUs because the bulk packages don't physically exist—the bulk packages are actually collections of smaller, pre-existing pre-set packages that already have their own SKUs.

To accommodate the increasing popularity and necessity of electronic sales, a manufacturer or retailer can use an electronic portal such as a website to sell diapers electronically. Sales can be made more convenient and efficient by offering virtual packaging and escalating discounts, while being able to optimize the mix of standard pre-set packages used to fulfill orders. Specifically, customers can be instructed to select between first and second order counts of personal care products for purchase. The first order count is one level of virtual bulk packaging, and the second order count is another level of virtual bulk packaging. The second order count is typically greater than the first order count. In addition, the first and second order counts each have a price per product, and the second order count typically has a price per product less than the price per product of the first order count.

Additional order counts that are larger or smaller than the first and second order counts can also be offered as choices. Order counts can be the same for each combination of size, variant, and gender, or order counts can vary by combination. In addition, the order count does not necessarily need to be entirely of one combination of size, variant, and gender, but can represent a mixture of such combinations. In this manner, the consumer is free to mix and match the different combinations as long as the consumer selects the appropriate number of each combination offered by the electronic display. For instance, a consumer can select numbers of different products representing different sizes, variants, and/or genders based upon individual preference.

The order counts offered to the consumer via the electronic display are typically based on the package counts of various pre-set packages of the particular combinations of size, variant, and gender in question. For instance, the first and second order counts can be multiples of a package count of a first pre-set package of the personal care products, of a second pre-set package of the personal care products, or of a combination thereof. For example, the first order count offered for a particular combination can be 240 based on the package count of the first pre-set package being 30, and the package count of the second pre-set package being 60. The order count of 240 is a multiple of both the 30-count package and the 60-count package.

Once the consumer selects and purchases a particular order count of one or more product combinations, the manufacturer or retailer can fulfill the purchase by determining the number of first and second pre-set packages to ship to meet the particular order count. Continuing with the example of the previous paragraph, the manufacturer or retailer can elect to fulfill the order count of 240 by shipping 8 30-count packages, 4 60-count packages, 4 30-count packages and 2 60-count packages, 2 30-count packages and 3 60-count packages, and so forth. The consumer typically has no input with respect to the mix of pre-set packages selected by the manufacturer or retailer to fulfill the selected order count.

The manufacturer or retailer fulfilling the order count can select what combination of pre-set packages to use to meet the order count by considering many factors including currently-available inventory, machine capacity, cost-to-manufacture, geography, shipping weight, and packing efficiency determined by the sizes and shapes of individual packages, boxes, trucks, and shipping containers. The manufacturer or retailer can select the combination manually or automatically. In this manner, the manufacturer or retailer has the flexibility to financially and temporally optimize the mixture of pre-set packages used to meet the order count. The multiple pre-set packages can then be bundled together and shipped to the consumer, thus providing cost savings for both the consumer and the manufacturer/retailer.

In various aspects of the present disclosure, the personal care products in the first pre-set package can be a variant, and/or can have a size, count, and/or gender of the personal care products, and the personal care products in the second pre-set package can be a variant, and/or can have a size, count, and/or gender of the personal care products that is different from those in the first pre-set package. For instance, a first variant can be a basic personal care product, and the second variant can be an enhanced personal care product. In this instance, for example, the enhanced personal care product can include a wetness indicator or can be an overnight personal care product.

In another instance, the personal care products in the first pre-set package are a first size of the personal care products, and the personal care products in the second pre-set package are a second size of the personal care products, wherein the second size is different from the first size. In still another instance, the personal care products in the first pre-set package are a first gender of the personal care products, and the personal care products in the second pre-set package are a second gender of the personal care products, wherein the second gender is different from the first gender.

In general, the personal care products in the first pre-set package are a first combination of variant, size, count, and gender of the personal care products, and the personal care products in the second pre-set package are a second combination of variant, size, count, and gender of the personal care products, and wherein the second combination is different from the first combination.

The electronic display described herein can be leveraged to showcase the brand quality of the different products and variants with appealing graphics and interactive tools if desired. The display, for instance, can provide product information, advertising, and other information, and can be synchronized and integrated with the packages to create a unified theme. In addition to providing product information, advertising, and other information, the display can also include instructions to assist consumers in selecting an order count and a product mix. For instance, the display can include instructions on how to select product combinations, and the number of each that are available to contribute toward the desired order count. The instructions, for instance, can instruct consumers to pick a certain number of the desired products that will become the desired order count. The instructions, product types, order counts, and product combinations can be made available for downloading and printing to allow the consumer to consider options offline. The instructions can be further used to guide the consumer through the selection of personal care products customized for their unique needs. The display can also include a calculator to help the consumer estimate how many personal care and other products will be needed per day and in total based on a variety of factors including a child's age, weight, habits, and eating, sleeping, and elimination patterns. For example, if the display contains absorbent articles, the display can assist a consumer in selecting size for their single child or multiple children and/or for selecting different products based on the child's characteristics. For instance, products worn at night can be matched with products worn during the day.

In a hypothetical example of the methods and systems described herein, diaper manufacturer X produces diapers for both genders in Size 1 and Size 2, and in Basic and Enhanced variants for a total of 8 combinations. Size 2 Basic diapers for girls, for example, are packaged in 5-count Mobile packages, 25-count Standard packages, and 50-count Value packages. Each of these packages is distributed to and sold by retail outlets. Larger retailer-specific packages in corrugate boxes are also distributed to and sold by some retail outlets. Larger packages, however, are not available to the consumer without visiting those retail outlets, or without using the corrugate boxes.

Manufacturer X addresses this need by offering, through electronic sales, large virtual packages. A consumer wishing to purchase Size 2 Basic diapers for girls at a discount is offered a virtual 200-count Mammoth package, and a virtual 400-count Ginormous package. The price per diaper of the Ginormous package is lower than the price per diaper of the Mammoth package, which is lower than the price per diaper of the Mobile, Standard, and Value packages in retail outlets.

Manufacturer X receives an order for a 400-count Ginormous package of Size 2 Basic diapers for girls, and assembles the package using an optimized mix of package sizes, such as 8 Value packages, 16 Standard Packages, 80 Mobile packages, 4 Value packages and 8 Standard packages, or any other combination of packages to meet the 400-count order. The consumer receives 400 diapers as ordered, and Manufacturer X has the flexibility to fulfill the order in an optimized way.

The large virtual packages are also advantageous in that they are not limited to a single combination of gender, size, and variant. A consumer with twins might order a 400-count Ginormous package that has 100 Size 2 Basic diapers for boys, 100 Size 2 Enhanced diapers for boys, 100 Size 2 Basic diapers for girls, and 100 Size 2 Enhanced diapers for girls. Manufacturer X can fulfill this order with any combination of the appropriate packages to meet the 400-count order.

When introducing elements of the present disclosure or the preferred aspect(s) thereof, the articles “a,” “an,” and “the” are intended to mean that there are one or more of the elements. The terms “comprising,” “including,” and “having” are intended to be inclusive and mean that there can be additional elements other than the listed elements.

The disclosure has been described with reference to various specific and illustrative aspects and techniques. However, it should be understood that many variations and modifications can be made while remaining within the spirit and scope of the disclosure. Many alternatives, modifications and variations will be apparent to those skilled in the art in light of the foregoing description. Accordingly, this disclosure is intended to embrace all such alternatives, modifications, and variations that fall within the spirit and scope of the appended claims.

What is claimed is:

1. A method of customizing bulk purchases of consumer personal care products comprising:
providing a consumer-accessible electronic display configured to allow a consumer to purchase the personal care products by selecting between first and second order counts of personal care products, wherein the first and second order counts are multiples of a package count of a first pre-set package of the personal care products, of a second pre-set package of the personal care products, or of a combination thereof; and
fulfilling the purchase by determining the number of first and second pre-set packages to ship to meet the selected order count.

2. The method of claim 1, wherein the personal care products in the first pre-set package are a first variant of the personal care products, and wherein the personal care products in the second pre-set package are a second variant of the personal care products, and wherein the second variant is different from the first variant.

3. The method of claim 2, wherein the first variant is a basic personal care product, and wherein the second variant is an enhanced personal care product.

4. The method of claim 3, wherein the enhanced personal care product includes a wetness indicator.

5. The method of claim 3, wherein the enhanced personal care product is an overnight personal care product.

6. The method of claim 3, wherein the enhanced personal care product is a limited-edition personal care product.

7. The method of claim 1, wherein the personal care products in the first pre-set package are a first size of the personal care products, wherein the personal care products in the second pre-set package are a second size of the personal care products, and wherein the second size is different from the first size.

8. The method of claim 1, wherein the personal care products in the first pre-set package are a first gender of the personal care products, wherein the personal care products in the second pre-set package are a second gender of the personal care products, and wherein the second gender is different from the first gender.

9. The method of claim 1, wherein the personal care products in the first pre-set package are a first combination of variant, size, and gender of the personal care products, wherein the personal care products in the second pre-set package are a second combination of variant, size, and gender of the personal care products, and wherein the second combination is different from the first combination.

10. The method of claim 1, wherein the second order count is greater than the first order count.

11. The method of claim 10, wherein the first order count has a price per product, and wherein the second order count has a price per product less than the price per product of the first order count.

12. The method of claim 1, wherein the consumer assembles a virtual order count by selecting personal care products of varying size, variant, and/or gender.

13. The method of claim 1, wherein the first and second order counts are also multiples of a package count of a third pre-set package of the personal care products, or of a combination of first, second, and third pre-set packages, and wherein fulfilling further comprises determining the number of first, second, and third pre-set packages to ship to meet the selected order count.

14. The method of claim 1, wherein a pre-set package is a package of the personal care products sold by a retailer.

15. The method of claim 1, wherein the personal care products comprise absorbent articles for infants and children.

16. A method as defined in claim 1, wherein the personal care products comprise feminine care products.

17. The method of claim 1, wherein determining includes a consideration of available inventory, machine capacity, cost-to-manufacture, shipping weight and/or packing efficiency.

18. A system for selling customized bulk purchases to consumers comprising:
a consumer-accessible electronic display configured to allow a consumer to purchase the personal care products by selecting between first and second order counts of personal care products, wherein the first and second order counts are multiples of a package count of a first pre-set package of the personal care products, of a second pre-set package of the personal care products, or of a combination thereof; and
an order fulfillment mechanism configured to determine the number of first and second pre-set packages to ship to meet the selected order count.

19. The system of claim 18, wherein the personal care products comprise absorbent articles for infants or children.

20. The system of claim 18, wherein the personal care products comprise absorbent articles and related products.

21. The system of claim 18, wherein the personal care products in the first pre-set package are a first combination of variant, size, and gender of the personal care products, wherein the personal care products in the second pre-set package are a second combination of variant, size, and gender of the personal care products, and wherein the second combination is different from the first combination.

22. A method of customizing bulk purchases of consumer personal care products comprising:
providing a consumer-accessible electronic display configured to allow a consumer to assemble and purchase a virtual combination of personal care products having one of first and second order counts, wherein the first and second order counts are multiples of a package count of a first pre-set package of the personal care products, of a second pre-set package of the personal care products, or of a combination thereof, wherein the second order count is greater than the first order count, wherein the first order count has a price per product, and wherein the second order count has a price per product less than the price per product of the first order count; and
fulfilling the purchase by determining the number of first and second pre-set packages to ship to meet the assembled combination.

23. The method of claim 22, wherein the personal care products in the first pre-set package are a first combination of variant, size, and gender of the personal care products, wherein the personal care products in the second pre-set package are a second combination of variant, size, and gender of the personal care products, and wherein the second combination is different from the first combination.
